(19) United States
(12) Patent Application Publication
(10) Pub. No.: US 2016/0036186 A1
(43) Pub. Date: Feb. 4, 2016

(54) Crimping Unit and Crimping Tool Thereof

(71) Applicant: HANLONG INDUSTRIAL CO., LTD., New Taipei City (TW)

(72) Inventors: Chien-Chou Liao, Tu Cheng City (TW); Yi-Hong Tsai, Tu Cheng City (TW)

(21) Appl. No.: 14/445,117

(22) Filed: Jul. 29, 2014

(51) Int. Cl. H01R 43/042

(52) U.S. Cl. CPC H01R 43/042

(57) ABSTRACT

A crimping unit and a crimping tool including the crimping unit are disclosed in the present invention. The crimping unit includes a plurality of headers. Each header includes at least one die. The plurality of headers are respectively pivotally connected to the crimping tool such that the headers can be rotated to switch the die.

### BACKGROUND OF THE INVENTION

1. Field of the Invention

The present invention relates to a crimping unit and a crimping tool; more particularly, the present invention relates to a crimping unit and a crimping tool having a switchable die.

2. Description of the Related Art

Currently, signal transmission is accomplished with many kinds of signal cables and signal connectors, such as the coaxial cable and connector for transferring cable television signals, the internet cable and RJ45 connector for transferring internet signals, and the telephone cable and RJ11 connector for transferring telephone signals. To connect a cable to a corresponding device, a corresponding connector must be installed on the end of a cable; usually, the manufacturer will use a crimping tool for a specific cable to connect the cable and the connector.

The crimping tool for cable of the prior art is used for crimping a connector with a specific specification; therefore, when crimping a connector with a different specification (such as an F-connector, or Bayonet Neill-Concelman connector), or crimping the connector with the same form and a different size (such as a different length), the manufacturer must use a different crimping tool. Although there is a crimping tool that has a removable crimping terminal to crimp cables of different specifications and forms, the crimping tool of the prior art still has many disadvantages.

Therefore, there is a need to provide a new crimping tool to solve the disadvantages of the prior art.

### SUMMARY OF THE INVENTION

It is an object of the present invention to provide a crimping unit having a switchable die.

It is another object of the present invention to provide a crimping tool with the abovementioned crimping unit wherein the crimping tool has a switchable die.

To achieve the abovementioned object, according to one embodiment of the present invention, the crimping unit of the present invention is applied to the crimping tool. The crimping unit includes a plurality of headers. Each of the plurality of headers includes at least one die, and the plurality of headers respectively are pivotally connected to the crimping tool such that the plurality of headers can be rotated to switch the at least one die.

According to one embodiment of the present invention, one header of the plurality of headers includes a convex lug, and the convex lug is located on an outer edge of the header. When the header rotates to a specific position, the convex lug interferes with the other headers and prevents the other headers from rotating.

According to one embodiment of the present invention, the specifications of the dies are different from each other.

According to one embodiment of the present invention, the plurality of headers include a first header and a second header. The first header includes a first die, the second header includes a second die and a third die, and the specifications of the first die, the second die, and the third die are different from each other. The second header comprises a convex lug, the convex lug being located on an outer edge of the second header, such that when the second header rotates to a specific position, the convex lug interferes with the first header and prevents the first header from rotating.

According to one embodiment of the present invention, the crimping unit of the present invention is applied to the crimping tool. The crimping unit includes a header. The header includes at least one die. The header is pivotally connected to the crimping tool such that the header can be rotated to switch the die.

According to one embodiment of the present invention, the crimping tool of the present invention includes an upper grip, a lower grip, a connecting rod, and a crimping unit. The lower grip is pivotally connected to the upper grip. The lower grip includes a chute and a container. The connecting rod is located in the chute, wherein one end of the connecting rod is pivotally connected to the upper grip and a briquetting is installed on another end. When force is applied to the upper grip, the connecting rod slides in the chute. The crimping unit is located in the container, and the crimping unit includes a plurality of headers. Each of the plurality of headers includes at least one die, and the plurality of headers are respectively pivotally connected to the lower grip such that the plurality of headers can be rotated to switch the die.

According to one embodiment of the crimping tool of the present invention, one header of the plurality of headers includes a convex lug, and the convex lug is located on an outer edge of the header. When the header rotates to a specific position, the convex lug interferes with the other headers and prevents the other headers from rotating.

According to one embodiment of the crimping tool of the present invention, the specifications of the dies are different from each other.

According to one embodiment of the crimping tool of the present invention, the plurality of headers include a first header and a second header, wherein the first header includes a first die and the second header includes a second die and a third die and the specifications of the first die, the second die, and the third die are different from each other. The second header includes a convex lug, the convex lug being located on an outer edge of the second header, such that when the second header rotates to a specific position, the convex lug interferes with the first header and prevents the first header from rotating.

According to one embodiment of the present invention, the crimping tool of the present invention includes an upper grip, a lower grip, a connecting rod, and a crimping unit. The lower grip is pivotally connected to the upper grip, and the lower grip includes a chute and a container. The connecting rod is located in the chute, one end of the connecting rod is pivotally connected to the upper grip, and a briquetting is installed on another end. When force is applied to the upper grip, the connecting rod slides in the chute. The crimping unit is located in the container, and the crimping unit includes a header. The header includes at least one die. The header is pivotally connected to the lower grip such that the header can be rotated to switch the die.

### BRIEF DESCRIPTION OF THE DRAWINGS

FIG. 1 illustrates a schematic drawing of the crimping tool according to the first embodiment of the present invention.

FIG. 2 illustrates an exploded perspective view of the crimping tool according to the first embodiment of the present invention.

FIG. 3 illustrates a schematic drawing of the convex lug according to the first embodiment of the present invention.

FIG. 4A, FIG. 4B, and FIG. 4C illustrate the operation schematic drawings of the crimping tool according to the first embodiment of the present invention.

FIG. 5 illustrates an exploded perspective view of the crimping tool according to the second embodiment of the present invention.

FIG. 6A and FIG. 6B illustrate the operation schematic drawings of the crimping tool according to the second embodiment of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

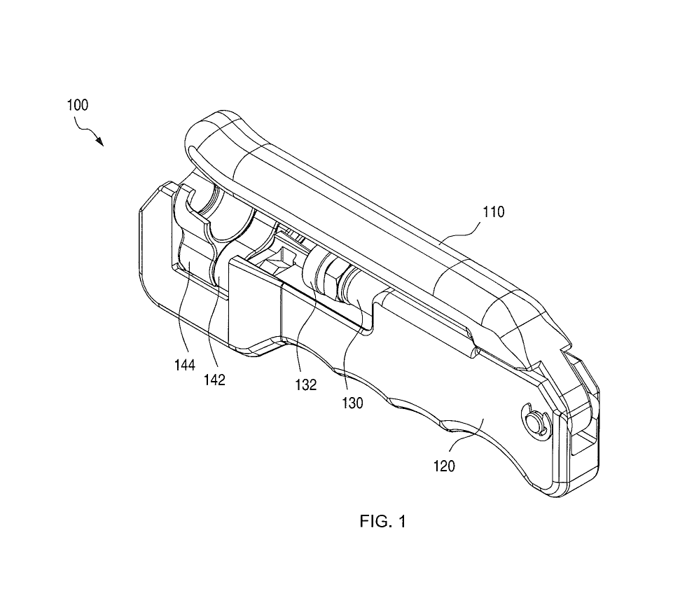

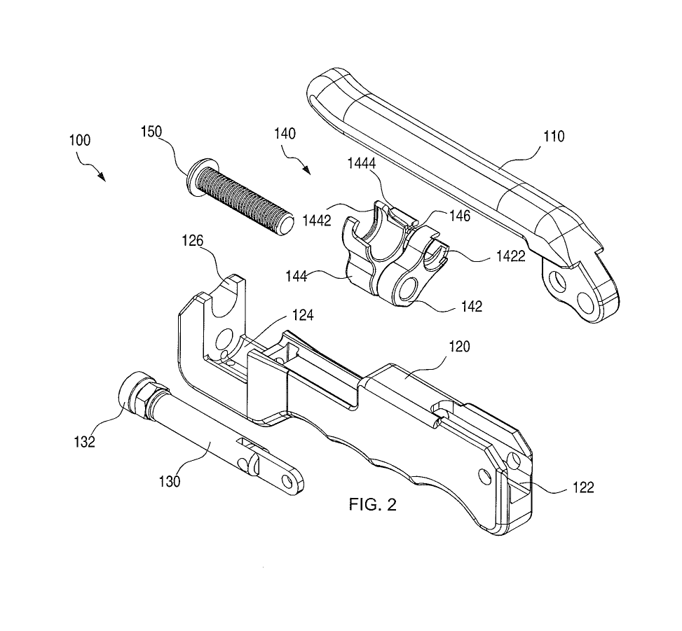

Please refer to FIG. 1 and FIG. 2. FIG. 1 illustrates a schematic drawing of the crimping tool according to the first embodiment of the present invention. FIG. 2 illustrates an exploded perspective view of the crimping tool according to the first embodiment of the present invention. As shown in FIG. 1 and FIG. 2, according to the first embodiment of the present invention, the crimping tool 100 includes an upper grip 110, a lower grip 120, a connecting rod 130, a crimping unit 140, and a screw shaft 150. The upper grip 110 and the lower grip 120 are represented as pole-shaped, wherein the lower grip 120 includes a chute 122 and a container 124. One end of the lower grip 120 is pivotally connected to the upper grip 110, and a die 126 is installed on another end. The user can apply force to the upper grip 110 and the lower grip 120 to cause the crimping tool 100 to switch between a crimping state and a releasing state. The chute 122 is a long strip space for allowing the connecting rod 130 to slide in the chute 122. The container 124 is located between the chute 122 and the die 126 and is for allowing the crimping unit 140 to be placed.

As shown in FIG. 1 and FIG. 2, according to the first embodiment of the present invention, the connecting rod 130 is a long strip and is located in the chute 122, wherein one end is pivotally connected to the upper grip 110 and a briquetting 132 is installed on another end. When the user applies force to the upper grip 110, the upper grip 110 drives the connecting rod 130, allowing the connecting rod 130 to slide in the chute 122, such that the briquetting 132 can move forward or backward.

As shown in FIG. 1 and FIG. 2, according to the first embodiment of the present invention, the crimping unit 140 is located in the container 124. The crimping unit 140 includes a first header 142 and a second header 144. One end of the first header 142 and the second header 144 can be respectively pivotally connected to the lower grip 120 via the screw shaft 150. Another end of the first header 142 includes a first die 1422. Another end of the second header 144 includes a second die 1442 and a third die 1444. Via rotating the first header 142 or the second header 144 to a suitable position, the first die 1422, the second die 1442, and the third die 1444 can be switched among. If the specifications of the first die 1422, the second die 1442, and the third die 1444 are different from each other, the user can choose a suitable die according to the connector to be crimped and then crimp the connector. It is to be understood that the amount of the headers and the amount of the dies on the header are not limited by the present embodiment; the amounts can be changed according to the actual requirements of the user. In addition, to allow the lower grip 120 to pivotally connect the first header 142 and the second header 144, the screw shaft 150 also has the functions of pushing and position limiting.

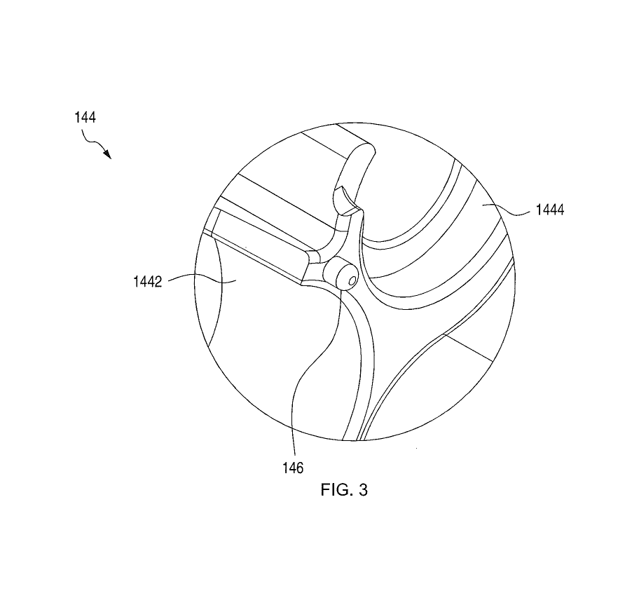

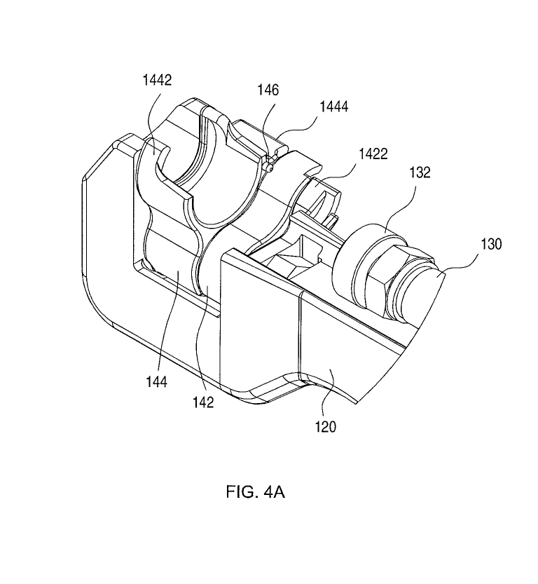

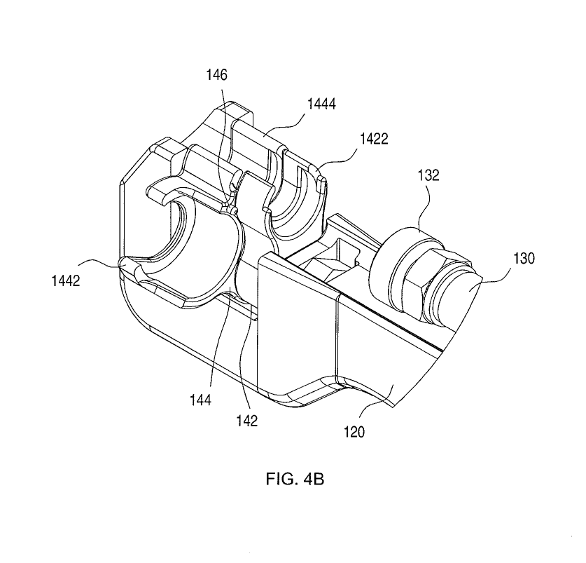

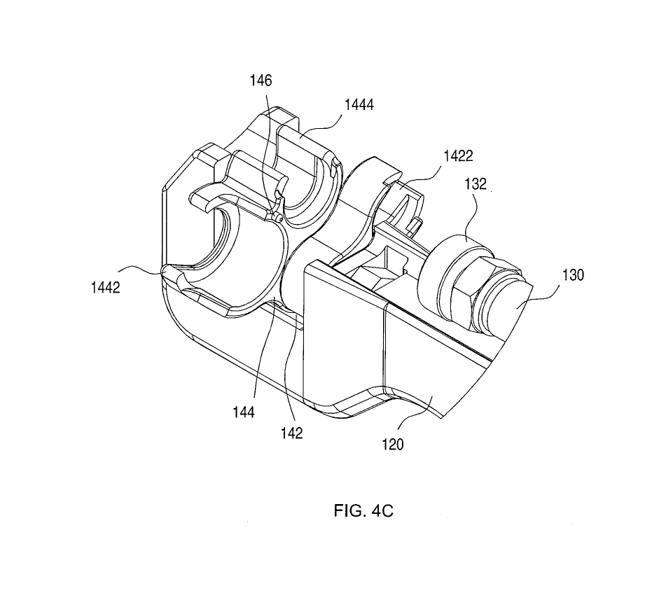

Please refer to FIG. 3, FIG. 4A, FIG. 4B, and FIG. 4C. FIG. 3 illustrates a schematic drawing of the convex lug according to the first embodiment of the present invention. FIG. 4A, FIG. 4B, and FIG. 4C illustrate the operation schematic drawings of the crimping tool according to the first embodiment of the present invention.

As shown in FIG. 3, according to the first embodiment of the present invention, the second header 144 includes a convex lug 146. The convex lug 146 is located on an outer edge of the header 144, and the convex lug 146 is used for preventing the first header 142 from rotating. As shown in FIG. 4A, FIG. 4B, and FIG. 4C, the user can switch among the first die 1422, the second die 1442, and the third die 1444 to choose a suitable die according to the connector which is to be crimped. For example, as shown in FIG. 4A, when crimping the connector which fits the second die 1442, the user can rotate the second die 1442 to a position towards the briquetting 132 and rotate the first die 1422 of the first header 142 to a position which is not towards the briquetting 132, such that the convex lug 146 can prevent the first header 142 from rotating. As shown in FIG. 4B, the user can also rotate the first die 1422 and the second die 1442 to a position towards the briquetting 132. As shown in FIG. 4C, when the user wants to crimp a connector that fits the third die 1444, the user can rotate the third die 1444 to a position towards the briquetting 132 and rotate the first die 1422 of the first header 142 to a position that is not towards the briquetting 132.

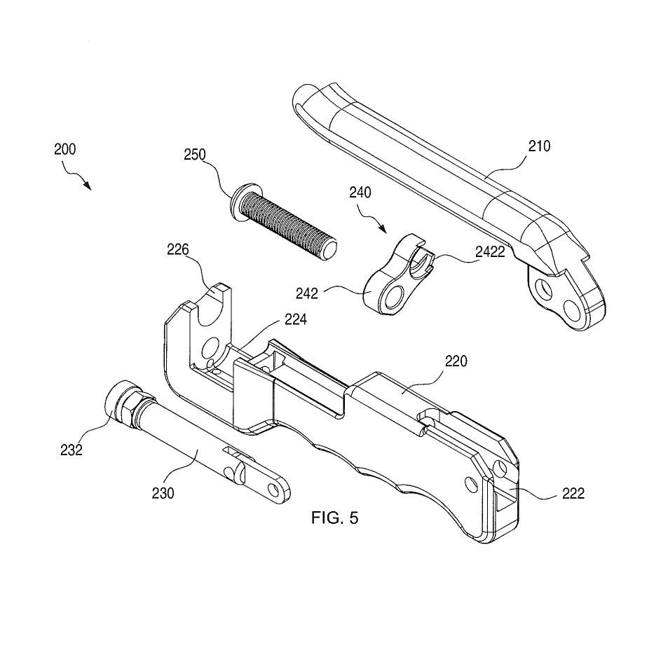

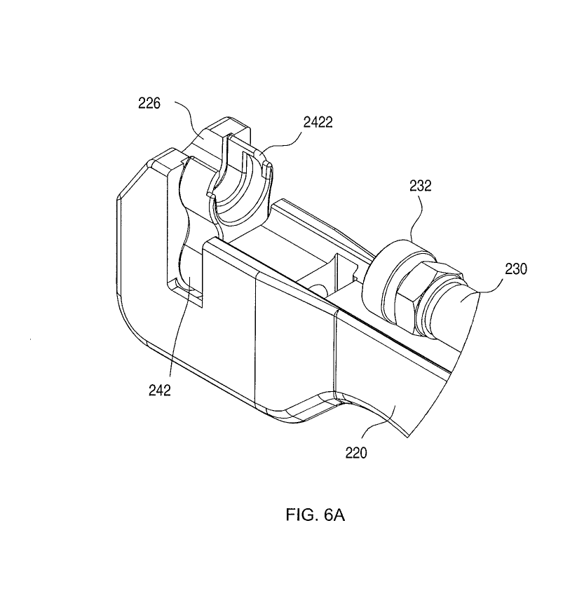

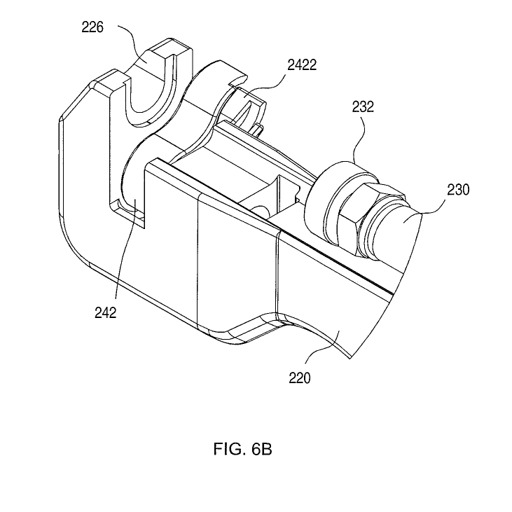

Please refer to FIG. 5, FIG. 6A, and FIG. 6B, which illustrate a second embodiment of the present invention. FIG. 5 illustrates an exploded perspective view of the crimping tool according to the second embodiment of the present invention. FIG. 6A and FIG. 6B illustrate the operation schematic drawings of the crimping tool according to the second embodiment of the present invention.

As shown in FIG. 5, according to the second embodiment of the present invention, the crimping tool 200 also includes an upper grip 210, a lower grip 220, a connecting rod 230, a crimping unit 240, and a screw shaft 250. The lower grip 220 includes a chute 222 and a container 224. One end of the lower grip 220 is pivotally connected to the upper grip 210, and a die 226 is installed on another end. The connecting rod 230 is located in the chute 222. One end of the connecting rod 230 is pivotally connected to the upper grip 210, and briquetting 232 is installed on another end. When the user applies force to the upper grip 210, the upper grip 210 drives the connecting rod 230 such that the connecting rod 230 slides in the chute 222. The difference between the second embodiment and the first embodiment is that the crimping unit 240 includes only a header 242, and the header 242 has only a die 2422. The header 242 is pivotally connected to the lower grip 220 via the screw shaft 250 such that the header 242 can be rotated to switch to the die 2422. In addition to allowing the header 242 to pivotally connect to the lower grip 220, the screw shaft 150 also has the functions of pushing and position limiting.

As shown in FIG. 6A, when the user wants to crimp a connector that fits the die 2422, the user can rotate the die 2422 to a position towards the briquetting 232. As shown in FIG. 6B, one end of the lower grip 220 has a die 226; therefore, when crimping a connector that fits the die 226, the user can rotate the header 242, allowing the die 2422 of the header 242 to be in a position which is not towards the briquetting 232, whereupon the user can use the die 226 to crimp directly. It is to be known that the amount of the dies on the header is not limited by the present embodiment; the amount can be changed according to the actual requirements of the user.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A crimping unit, applied to a crimping tool, the crimping unit comprising:
a plurality of headers, each of the plurality of headers comprising at least one die, the plurality of headers being respectively pivotally connected to the crimping tool such that the plurality of headers can be rotated to switch the at least one die.

2. The crimping unit as claimed in claim 1, wherein one header of the plurality of headers comprises a convex lug, and the convex lug is located on an outer edge of the header; when the header rotates to a specific position, the convex lug interferes with the other headers and prevents the other headers from rotating.

3. The crimping unit as claimed in claim 2, wherein the specifications of each of the at least one dies are different from each other.

4. The crimping unit as claimed in claim 1, wherein the plurality of headers comprise a first header and a second header; the first header comprises a first die, the second header comprises a second die and a third die, and the specifications of the first die, the second die, and the third die are different from each other, wherein the second header comprises a convex lug, the convex lug being located on an outer edge of the second header, such that when the second header rotates to a specific position, the convex lug interferes with the first header and prevents the first header from rotating.

5. A crimping unit, applied to a crimping tool, the crimping unit comprising:
a header, comprising at least one die, the header being pivotally connected to the crimping tool, allowing the header to be rotated to switch the at least one die.

6. A crimping tool, comprising:
an upper grip;
a lower grip, pivotally connected to the upper grip, the lower grip comprising a chute and a container;
a connecting rod, located in the chute, wherein one end of the connecting rod is pivotally connected to the upper grip, and a briquetting is installed on another end; when force is applied to the upper grip, the connecting rod slides in the chute; and
a crimping unit, located in the container, the crimping unit comprising: at least one header, each of the at least one header comprising at least one die, each of the at least one header being respectively pivotally connected to the lower grip such that the at least one header can be rotated to switch the at least one die.

7. The crimping tool as claimed in claim 6, wherein the at least one header comprising a plurality of headers.

8. The crimping tool as claimed in claim 7, wherein one header of the plurality of headers comprises a convex lug, the convex lug being located on an outer edge of the header, such that when the header rotates to a specific position, the convex lug interferes with the other headers and prevents the other headers from rotating.

9. The crimping tool as claimed in claim 8, wherein the specifications of each of the at least one die are different from each other.

10. The crimping tool as claimed in claim 7, wherein the plurality of headers comprise a first header and a second header; the first header comprises a first die, the second header comprises a second die and a third die, and the specifications of the first die, the second die, and the third die are different from each other, wherein the second header comprises a convex lug, the convex lug being located on an outer edge of the second header, such that when the second header rotates to a specific position, the convex lug interferes with the first header and prevents the first header from rotating.
